(19) United States
(12) Patent Application Publication
(10) Pub. No.: US 2026/0290940 A1
(43) Pub. Date: Sep. 24, 2026

(54) A TRAY AND A SYSTEM FOR HOUSING A PLURALITY OF INDIVIDUAL BATTERY MODULES, AND A METHOD FOR COOLING A PLURALITY OF BATTERY MODULES HOUSED IN A TRAY OF SUCH A SYSTEM

(71) Applicant: SABIC GLOBAL TECHNOLOGIES B.V., Bergen op Zoom (NL)

(72) Inventors: Sreekanth PANNALA, Sugar Land, TX (US); Tingwen LI, Sugar Land, TX (US); Fred CHANG, Oakland Township, MI (US); Dinesh MUNJURULIMANA, South Lyon, MI (US)

(21) Appl. No.: 19/473,006

(22) PCT Filed: Mar. 19, 2024
(86) PCT No.: PCT/EP2024/057343

§ 371 Date: Oct. 6, 2025

(30) Foreign Application Priority Data
Apr. 14, 2023 (EP) 23168131.3

(51) Int. Cl. H01M 10/6557; H01M 10/613; H01M 10/63; H01M 10/653; H01M 10/6561; H01M 10/6568; H01M 50/209; H01M 50/244; H01M 50/291

(52) U.S. Cl. CPC H01M 10/6557; H01M 10/613; H01M 10/63; H01M 10/653; H01M 10/6561; H01M 10/6568; H01M 50/244; H01M 50/291; H01M 50/209

(57) ABSTRACT

The present invention relates to a tray for housing a plurality of individual battery modules, the tray comprising a bottom wall and side walls defining a receiving space for the plurality of individual battery modules, wherein the tray has one or more inner walls extending between opposite side walls and subdividing the receiving space in a plurality of individual battery module receiving chambers each bounded by a part of the bottom wall and by one or more side walls and/or inner wall or walls, and a coolant inlet and a coolant outlet, wherein at least one of the side walls and/or at least one of the one or more inner walls comprises a plate shaped base part made of a thermoplastic material and comprising a wall-channel for a flow of a coolant medium on at least one plate side of the base part, wherein the wall-channel is in connection with the coolant inlet and with the coolant outlet such that a coolant medium can flow through the wall-channel, and a thermoplastic-based layer bonded to the base part such that it covers and thereby closes off the wall-channel, wherein the wall concerned is oriented in the tray such that it faces one or more of the battery module receiving chambers with a plate side thereof having the layer bonded thereto. The invention also relates to a system including one or more of said trays and a cooling system as well as to a method for cooling a plurality of battery modules.

### FIELD OF THE INVENTION

In one aspect, the invention relates to a tray for housing a plurality of individual battery modules. In another aspect, the invention relates to a system for housing a plurality of individual battery modules, comprising one or more such trays. In a further aspect, the invention relates to a method for cooling a plurality of battery modules housed in a tray of such a system.

### BACKGROUND

Generally, battery modules, such as lithium-ion battery modules, involve a substantial risk of thermal runaway in case of local failure of a battery cell of a battery module. Such local failure may result from mechanical impact, for example during an electric vehicle crash or dendrite formation and internal short upon overcharge or impurities or imperfection of the cell or thermal abuse. In case of thermal runaway, the battery module keeps re-igniting, which makes it very difficult and time-consuming to extinguish.

Trays for battery modules are generally casted from aluminum.

It is an object to provide a tray for housing a plurality of individual battery modules, having an improved cooling provision. It is another object of the invention to provide a tray for housing a plurality of individual battery modules, having an integrated cooling provision, which tray can be manufactured in an easy and cost-efficient manner.

It is a further object of the invention to provide a tray for housing a plurality of individual battery modules, in which the chance of a catastrophic thermal runaway in case of battery cell failure may effectively be reduced. It is an object to provide a tray for housing a plurality of individual battery modules, in which it is possible to locally respond to a battery cell failure.

### SUMMARY

One or more of the above objects are achieved by the tray according to an aspect of the invention, for housing a plurality of individual battery modules, the tray comprising a bottom wall and side walls defining a receiving space for the plurality of individual battery modules, wherein the tray has one or more inner walls extending between opposite side walls and subdividing the receiving space in a plurality of individual battery module receiving chambers each bounded by a part of the bottom wall and by one or more side walls and/or inner wall or walls, and a coolant inlet and a coolant outlet,
wherein at least one of the side walls and/or at least one of the one or more inner walls comprises:
   a plate shaped base part made of a thermoplastic material and comprising a wall-channel for a flow of a coolant medium on at least one plate side of the base part, wherein the wall-channel is in connection with the coolant inlet and with the coolant outlet such that a coolant medium can flow through the wall-channel, and
   a thermoplastic-based, preferably a polyolefin-based layer, particularly preferably a polyolefin-based film, bonded to the base part such that it covers and thereby closes off the wall-channel, wherein the wall concerned is oriented in the tray such that it faces one or more of the battery module receiving chambers with a plate side thereof having the layer bonded thereto.

In another aspect, the invention relates to a system for housing a plurality of individual battery modules, comprising:
one or more trays according to the invention; and
a cooling system comprising:
   a supply line connected to a coolant inlet of each of the one or more trays;
   a discharge line connected to the coolant outlet of each of the one or more trays; and
   a flow generating device, such as a pump, for generating a circulating flow of the coolant medium through the supply line, via the wall-channel, and optionally the bottom-channel, and the discharge line.

In yet another aspect, the invention relates to a method for cooling a plurality of battery modules housed in a tray of a system according to the invention, comprising:
forcing, using the flow generating device, a flow of coolant medium through the wall-channel, and optionally the bottom-channel, in the one or more trays.

Below several preferred features of the invention are disclosed. These features are applicable to the tray, to the system as well as to the method in accordance with the present invention.

An effect of the tray, system and method according to the invention is that because of the configuration of the at least one of the side walls and/or at least one of the one or more inner walls, having the base part with a wall-channel which is covered by the thermoplastic-based (preferably polyolefin-based) layer, a local battery cell failure which leads to the (local) overheating of the battery cell concerned, results in a local melting of the thermoplastic-based layer thereby creating a local fissure (or puncture or opening or perforation) in the thermoplastic-based layer near the location of the failure of the cell. As a result, a spray of coolant medium immediately emerges from the wall-channel, through the local opening and against the battery cell, reducing the temperature of said battery cell locally and acting like a local fire extinguisher dissipating the heat passively. This contributes to preventing further propagation of the thermal runaway within the cell and in turn to other cells and modules.

### DESCRIPTION OF THE DRAWINGS

The present invention is described hereinafter with reference to the accompanying schematic drawings in which examples of the present invention are shown and in which like reference numbers indicate the same or similar elements.

FIG. 1a shows an isometric view of an example of a tray according to an aspect of the invention, wherein five battery modules are received in the receiving space of the tray. FIG. 1b shows an isometric view of the tray of FIG. 1a, wherein the receiving space of the tray is fully occupied by battery modules. FIG. 1c shows a more detailed isometric view of an individual battery module receiving chamber of the tray of FIGS. 1a and 1b.

FIG. 2 shows a more detailed isometric view of an example of the bottom wall, one of the side walls and one of the inner walls of the tray according to an aspect of the invention.

FIG. 3 shows an isometric view of another example of one of the one or more inner walls of the tray according to an aspect of the invention.

FIG. 4 shows a cross-sectional view of a part of the tray according to an aspect of the invention.

FIG. 5 shows a close-up of a part of one of the side walls and/or one of the one or more inner walls of the tray according to an aspect of the invention, in case of overheating of a cell of a battery module.

FIG. 6 shows schematically an example of a system according to another aspect of the invention.

FIG. 7 shows schematically an example of a method according to another aspect of the invention.

FIGS. 8a,b discloses a test set-up to test the concept of the present system and method.

### DETAILED DESCRIPTION

The present invention is elucidated below with a detailed description. Unless otherwise defined or specified, all terms should be accorded a technical meaning consistent with the usual meaning in the art as understood by the skilled person.

All parameter ranges include the endpoints of the ranges and all values in between the endpoints, unless otherwise specified. When used in these specification and claims, the terms “comprise” and “comprising” and variations thereof mean that the specified features, steps, or integers are included. The terms are not to be interpreted to exclude the presence of other features, steps, or components.

A tray is defined as an open receptacle with a bottom wall and side walls for holding a plurality of battery cells. Bottom wall is defined as the wall closing the underside of the tray and together with the side walls forming a receiving space. Side wall is defined as a wall closing the sides of the tray and together with the bottom wall forming a receiving space. Generally, the tray has one bottom wall and four side walls, defining a rectangular receiving space. Inner wall is defined as a wall that subdivides the receiving space formed by the bottom wall and side walls. Inner walls extend between opposing side walls. In an embodiment, there are two at least inner walls of the tray which extend perpendicular to each other thereby subdividing the receiving space in at least four battery module receiving chambers in a matrix-shape of at least two by at least two battery module receiving chambers. If there are several inner walls that extend between other inner walls, the total of inner walls in one direction is considered to extend between opposing side walls. Inner walls subdivide the receiving space into receiving chambers or chambers for receiving battery modules or battery cells. These receiving chambers may be in matrix form by a series of parallel inner walls extending in a first direction between a first pair of opposing side walls and a series of parallel inner walls in a direction perpendicular to said first series and extending between a second pair of opposing side walls, that are perpendicular to said first pair of opposing side walls.

A battery module is defined as either an individual battery cell or as an assembly of multiple interconnected battery cells.

At least one of the one or more inner walls may comprise a plate shaped base part comprising a said wall-channel on both plate sides of the base part, and a respective said thermoplastic-based layer bonded to either plate side of the base part to cover and thereby close off the respective wall-channel. This allows for the cooling of the battery modules on both sides of the inner wall concerned.

Bottom-channel is defined as a channel in a bottom wall. Wall-channel is defined as a channel in either a side wall or an inner wall. Plate side is defined as the side of the base part that is plate shaped, in contrast to the edges of said plate shaped based part.

The wall-channel may have multiple branches such that the coolant medium flows via the multiple branches in use. This might allow for better distribution of the coolant medium over the full surface of the walls. Branches are defined as a sub-channels arising from the main channel.

The bottom wall may as well comprise a said plate shaped base part made of a thermoplastic material and comprising a bottom-channel for a flow of a coolant medium on at least one plate side of the base part, wherein the bottom-channel is in connection with the coolant inlet and with the coolant outlet such that a coolant medium can flow through the bottom-channel, the bottom wall further comprising a thermal conductive layer, preferably a thermal conductive film, bonded to the base part such that it covers and thereby closes off the bottom-channel, wherein the bottom wall is oriented such that it faces the receiving space with an inner plate side thereof having the layer bonded thereto. For this embodiment, the flow generating device of the system according to the invention may also be arranged for generating a circulating flow of the coolant medium through the supply line, via the bottom-channel and the discharge line. The method according to the invention may in this regard comprise forcing, using the flow generating device, a flow of coolant medium through the bottom-channel in the one or more trays.

At least 20 percent of a plate surface of each wall part enclosing each of the battery module chambers may be free from the wall-channel, and optionally the bottom-channel, so as to serve as an abutment for positioning the battery module in the chamber concerned. Wall part is defined as part of a bottom wall, side wall and/or inner wall that encloses each of the battery module (receiving) chambers.

Inner walls of the tray may extend perpendicular to each other and may subdivide the receiving space in at least four said battery module receiving chambers in a matrix-shape of at least two by at least two battery module receiving chambers,
wherein the inner walls may each comprise a slot such that each time two inner walls can be interlocked perpendicular to each other with a first of the two inner walls extending through the slot in the second of the two inner walls and with the second of the two inner walls extending through the slot in the first of the inner walls,
wherein, in each inner wall, the at least one wall-channel may extend in the inner wall remaining free from the slot. Slot is defined as an opening or groove, preferably a narrow opening or groove, in a side wall or inner wall for receiving part of another side wall or inner wall.

As mentioned above, the invention relates to a system that comprises a cooling system, said cooling system comprising a supply line connected to the coolant inlet(s) of a tray, and a discharge line connected to the coolant outlet(s) of a tray as well as a a flow generating device, such as a pump, for generating a circulating flow of the coolant medium through the supply line, via the wall-channel, and optionally the bottom-channel, and the discharge line.

Coolant inlet is defined as an inlet present in the tray that allows coolant medium to enter the one or more wall channels (and one or more bottom channels) in said tray. It may be envisaged that each side wall and optionally each inner wall (and optionally the bottom wall) have a separate coolant inlet or that one specific coolant inlet is provided from the tray. Coolant outlet is defined as an outlet present in the tray that allows coolant medium to leave the one or more wall channels and one or more bottom channels in said tray. It may be envisaged that each side wall and optionally each inner wall (and optionally the bottom wall) have a separate coolant outlet or that one specific coolant outlet is provided from the tray.

The coolant may be present under pressure, this will show a certain amount of elastic stretch of the thermoplastic-based layer of the side walls and optionally the inner walls (and optionally the thermal conductive layer of the bottom wall). This will ensure, during use, an improved contact and lower thermal contact resistance with the battery cell. The cooling system may be configured for pressurizing the coolant medium, for example at a pressure between 0.5-20 Barg. The thermoplastic-based layer and optionally the thermal conductive layer are elastically stretched as a result of the pressurized coolant medium.

Coolant medium is defined as a medium that is used for cooling. Examples thereof are a (pressurized) coolant fluid, such as a coolant gas, a coolant liquid or a mixture of a coolant liquid or a gas. In addition, a coolant gel may be mentioned. Preferably, said coolant medium is a mixture of water and ethylene glycol. Ethylene glycol is commonly used to reduce the freezing point of water; it is generally not used in pure form because it is so viscous. With mixtures of water and ethylene glycol, there is a balance between the viscosity (less ethylene glycol) and a lower freezing point (more ethylene glycol). The exact proportion of water and ethylene glycol may be determined by a person skilled in the art and depend on the temperature of use and the desired viscosity. A mixture of about 1:1 water:ethylene glycol (around 50% glycol) is generally used and is suitable for the present invention.

The system according to the invention may further comprise a coolant medium reservoir connected to the supply line or to the discharge line via a valve in such a manner that said coolant medium flows through the wall-channel, and optionally the bottom-channel, upon opening the valve. Coolant medium reservoir is defined as a reservoir containing a coolant medium and optionally also fire suppressant that is present outside of the tray.

Fire suppressant is defined as an agent that suppresses fire, for example a chemical compound that interferes with the free radicals (mainly hydrogen radicals, hydroxy radicals, or oxygen radicals) that are present in the combustion phase of a fire), such as potassium citrate. Such a fire suppressant may be present in addition to a coolant medium in the event that the battery pack not only shows thermal runaway but ends up igniting forming a fire.

The system may comprise a pressure sensor for detecting a pressure drop in the wall-channel, and optionally the bottom-channel, as a result of a local melting of the thermoplastic-based (preferably polyolefin-based) layer as a result of heat generated by a battery module in the tray, wherein the pressure sensor is connected to the valve such that the valve opens upon detection of said pressure drop by the pressure sensor.

The coolant medium may comprise a pressurized coolant fluid, preferably a coolant liquid or a pressurized mixture of a coolant liquid and a gas. Examples of coolant medium are dielectric liquid coolants having the effect that the leak does not create an electric short; examples thereof are transformer oil, perfluoroalkanes, and purified water. Preferably the coolant medium comprises water and ethylene glycol and optionally a fire suppressant.

Using the cooling system, the coolant medium may be pressurized such that the thermoplastic-based layer is elastically stretched as a result of the pressurized coolant medium, increasing a heat transfer from the battery modules to the coolant medium as a result of an increased contact between the layer and the battery modules. As mentioned above, plate shaped base parts of the bottom wall, side wall and optionally inner walls are made of a thermoplastic material, for example polyolefin materials.

Said thermoplastic material may be selected from the group consisting of for example polypropylene with low specific gravity or thermally conductive polycarbonate, such as UL94 V0 polyolefin compounds with high specific strength and specific stiffness, UL94 V0 high flow engineering thermoplastic compounds with good adhesive compatibility for thin gauge internal components, and any of a family of polyester compounds with low temperature ductility for impact absorbers. LEXAN 945 and CYCOLOY 7240 may be mentioned as examples thereof. The thermoplastic material may comprise one or more of the following: additives and/or stabilizers like anti-oxidants, UV stabilizers, pigments, dyes, adhesion promoters, and a flame retardant e.g. mixture of an organic phosphate compound (for example piperazine pyrophosphate, piperazine polyphosphate and combinations thereof), an organic phosphoric acid compound (for example phosphoric acid, melamine pyrophosphate, melamine polyphosphates, melamine phosphate) and combinations thereof, and zinc oxide, and/or a filler, e.g., fibers or talc. For example, a fiber-filled polyolefin can be used as thermoplastic material. Possible fiber material may include at least one of glass, carbon, aramid, or plastic, preferably glass. The fiber length can be chopped, long, short, or continuous. In particular, long glass fiber-filled polypropylene (e.g., STAMAX™ available from SABIC) can be used as the thermoplastic material. Long fibers can be defined to have an initial fiber length, before molding, of at least 3 mm. For example, talc filled PP may also be used as it has good shrinkage/warpage behavior.

The thermoplastic-based layer that is present on the side walls and optionally the inner walls are preferably a polyolefin-based film but may also be an injected molded or otherwise prepared part, such as a shell. The polyolefin may be for example be an ethylene-based polymer or a propylene-based polymer. Preferably, the polyolefin has a peak melting temperature (T_{p,m}) of at least 100° C., as determined in accordance with ASTM D3418 (2008), preferably of at least 120 or at least 140° C.

The thermoplastic-based layer may be polyvinyl halide polymer-based layer, preferably a polyvinyl halide polymer-based film, such a polyvinyl chloride (PVC) material being a thermoplastic chloropolymer having a repeating vinyl chloride unit or a polyvinyl fluoride (PVF) material being a thermoplastic fluoropolymer having a repeating vinyl fluoride. The thermoplastic-based layer/film may also be of one or more of the following materials: i) polyetherimide (PEI) (e.g., ULTEM®), ii) a modified resin consisting of amorphous blends of polyphenylene oxides (PPO) or polyphenylene ether (PPE) resins with polystyrene (e.g., NORYL®), iii) a polycarbonate (PC) (e.g., LEXAN®), iv) a semi-crystalline material of polybutylene terephthalate (PBT) and/or polyethylene terephthalate (PET) optionally blended with polycarbonate (PC) (e.g., VALOX®); or v) polyamides (PA). Preferably, the thermoplastic material has a peak melting temperature (Tpm) of at least 100° C., as determined in accordance with ASTM D3418 (2008), preferably of at least 120 or at least 140° C.

The polyolefin-based layer may be selected from the group consisting of a biaxially oriented polypropylene (BOPP) film, a biaxially oriented polyethylene (BOPE) film, or a film comprising one or more layers, preferably at least a core layer and two outer layers.

The ethylene-based polymer may for example be a homopolymer of ethylene, or a copolymer of ethylene and one or more α-olefin, preferably wherein the α-olefin comprises 1-10 carbon atoms, more preferably wherein the α-olefin is selected from 1-butene, 1-hexene, or 1-octene. For example, the ethylene-based polymer may comprise ≥80.0 wt. % of moieties derived from ethylene, preferably ≥90.0 wt. %, more preferably ≥95.0 wt. %, with regard to the total weight of the ethylene-based polymer. For example, the ethylene-based polymer may comprise ≤20.0 wt. % of moieties derived from 1-butene, 1-hexene, or 1-octene, preferably ≤10.0 wt. %, more preferably ≤5.0 wt. %.

The ethylene-based polymer may for example have a density of ≥870 kg/m³, preferably of ≥870 and ≤975 kg/m³, more preferably of ≥900 and ≤975 kg/m³, even more preferably ≥945 and ≤970 kg/m³, as determined in accordance with ASTM D792 (2008).

The ethylene-based polymer may for example have a melt mass-flow rate of ≥0.1 and ≤10.0 g/10 min, preferably ≥0.1 and ≤5.0 g/10 min, more preferably ≥0.2 and ≤3.5 g/10 min, as determined in accordance with ASTM D1238 (2013), at 190° C. under a load of 2.16 kg.

The polypropylene-based film may comprise a propylene homopolymer, a propylene-ethylene copolymer, or a propylene-ethylene-C4-terpolymer or a propylene-ethylene-C6-terpolymer, wherein the copolymer of terpolymers have an ethylene content of at most 4.0 wt. %, such as between 3.0 and 4.0 wt. % or in another embodiment at most 1.5 wt. % based on the weight of the copolymer or terpolymer; wherein said homopolymer, copolymer or terpolymer has: i) a Mw/Mn in the range of 4.0 to 12, preferably 5.0 to 12 wherein Mw stands for the weight average molecular weight and Mn stands for the number average molecular weight and wherein Mw and Mn are measured according to ASTM D6474-12; ii) an XS in the range from 1.0 to 8.0 wt. %, preferably from 1.0 to 6.0 wt. %, wherein XS stands for the amount of xylene solubles which are measured according to ASTM D 5492-10; and iii) a melt flow rate in the range of 1 to 10 dg/min as measured according to IS01133-1 (2011) (2.16 kg/230° C.).

The polyolefin film may for example be a bidirectionally oriented film (BO film), wherein the orientation is introduced in the solid state. For example, the BO film may be oriented at a temperature of at least 10° C. below T_{p,m}. The BO film may for example have a thickness of ≥50 and ≤500 μm, preferably ≥50 and ≤300 μm. The BO film may be oriented to a degree of orientation of ≥5.0 and ≤25.0 in the machine direction. The BO film may be oriented to a degree of orientation of ≥5.0 and ≤25.0 in the transverse direction. The BO film may be oriented to a degree of orientation of ≥5.0 and ≤25.0 in the machine direction and ≥5.0 and ≤25.0 in the transverse direction. In this context, the degree of orientation is defined as the ratio of the dimension of the film after being subjected to orientation over the dimension of the film prior to orientation, in each of the machine and the transverse direction. The BO film may be produced by cast melt extrusion of a film, cooling the film to a temperature of at least 10° C. below T_{p,m}, followed by stretching the film in the machine direction and the transverse direction. The stretching may be performed simultaneously in both directions, or sequentially, first in the machine direction and then in the transverse direction, or first in the transverse direction and then in the machine direction.

The thermoplastic-based layer may be a multilaminate film comprising an aluminum core layer in between two polyolefin-based outer layers. Such a laminate has the advantage that the aluminum core layer provides excellent thermal conductivity to dissipate heat away from the local hotspot to prevent or delay local overheating and local melting of the outer thermoplastic-based layer. The thermoplastic-based layer ensures easy fixing of the thermally conductive layer to the side wall or inner walls, e.g., by melt-fixing the polyolefin of the thermally conductive layer to the thermoplastic material of the side wall or inner walls. The aluminum core layer may have a thickness of between 20 and 100 micron. The aluminum core layer is preferably a perforated layer, but it may be a solid layer (viz. without perforations). In the former case in the event of local melting a local puncture (fissure or opening or perforation) may be formed leading to localized release (spray) of coolant medium that is present in the wall channels. When a polypropylene based material is used for the side wall and/or bottom wall and when an aluminum comprising layer is used, it is preferred that the side of the layer that will be adhered to the side wall and/or bottom wall is also a polypropylene based material to ensure optimal bonding.

The amount of thermoplastic material in the thermoplastic-based layer may e.g. be at least 50 wt %, at least 60 wt %, at least 70 wt %, at least 80 wt %, at least 90 wt % or at least 95 wt %, with respect to the total thermoplastic-based layer.

The amount of thermoplastic material in the thermoplastic-based layer may e.g. be 10 to 90 wt % with respect to the total thermoplastic-based layer.

The thermoplastic-based layer may be a multilaminate film comprising an aluminum core layer in between two thermoplastic-based outer layers, wherein the amount of thermoplastic material in the multilaminate film is 10 to 90 wt % and the amount of aluminum in the multilaminate film is 10 to 90 wt % with respect to the total multilaminate film.

The amount of polyolefin in the polyolefin-based layer may e.g. be at least 50 wt %, at least 60 wt %, at least 70 wt %, at least 80 wt %, at least 90 wt % or at least 95 wt %, with respect to the total polyolefin-based.

The amount of polyolefin in the polyolefin-based layer may e.g. be 10 to 90 wt % with respect to the total polyolefin-based layer.

The polyolefin-based layer may be a multilaminate film comprising an aluminum core layer in between two polyolefin-based outer layers, wherein the amount of polyolefin in the multilaminate film is 10 to 90 wt % and the amount of aluminum in the multilaminate film is 10 to 90 wt % with respect to the total multilaminate film.

The thermally conductive layer that is present on the bottom wall in the embodiment in which one or more bottom channels are present in the bottom wall, is preferably a thermally conductive film but may also be an injected molded or otherwise prepared part, such as a shell. The thermally conductive layer may be of the same materials as discussed above for the thermoplastic-based (preferably polyolefin-based) layers. The thermally conductive layer may be a multilaminate film comprising an aluminum core layer in between two polyolefin-based outer layers or an outermost aluminum layer and an inner thermoplastic-based (preferably polyolefin-based) layer. Such a laminate has the advantage that the aluminum core layer provides excellent thermal conductivity to dissipate heat away from the local hotspot to prevent or delay local overheating and local melting of the outer thermoplastic-based (preferably polyolefin-based) layer. The thermoplastic-based layer ensures easy fixing of the thermally conductive layer to the bottom wall, e.g., by melt-fixing the polyolefin of the thermally conductive layer to the thermoplastic material of the bottom wall. The aluminum core layer may have a thickness of between 20 and 100 micron. The aluminum core layer is preferably a solid layer (viz. without perforations), however it may be a perforated layer. In the latter case in the event of local melting a local fissure may be formed leading to localized release (spray) of coolant medium that is present in the bottom channels underneath the thermally conductive layer.

The thermal conductive layer may comprise the same materials as discussed above for the thermoplastic-based (preferably polyolefin-based) layers.

The thermal conductive layer may comprise thermoplastic material in an amount of at least 50 wt %, at least 60 wt %, at least 70 wt %, at least 80 wt %, at least 90 wt % or at least 95 wt %, with respect to the total thermal conductive layer.

The thermal conductive layer may comprise thermoplastic material in an amount of 10 to 90 wt % with respect to the total thermal conductive layer.

The thermal conductive layer may be a multilaminate film comprising an aluminum core layer in between two thermoplastic-based outer layers or an outermost aluminum layer and an inner thermoplastic-based layer, wherein the amount of thermoplastic material in the multilaminate film is 10 to 90 wt % and the amount of aluminum in the multilaminate film is 10 to 90 wt %, with respect to the total multilaminate film.

The thermal conductive layer may comprise polyolefin in an amount of at least 50 wt %, at least 60 wt %, at least 70 wt %, at least 80 wt %, at least 90 wt % or at least 95 wt %, with respect to the total thermal conductive layer.

The thermal conductive layer may comprise polyolefin in an amount of 10 to 90 wt % with respect to the total thermal conductive layer.

The thermal conductive layer may be a multilaminate film comprising an aluminum core layer in between two polyolefin-based outer layers or an outermost aluminum layer and an inner polyolefin-based layer, wherein the amount of polyolefin in the multilaminate film is 10 to 90 wt % and the amount of aluminum in the multilaminate film is 10 to 90 wt %, with respect to the total multilaminate film.

The drawings are disclosed in more detail below.

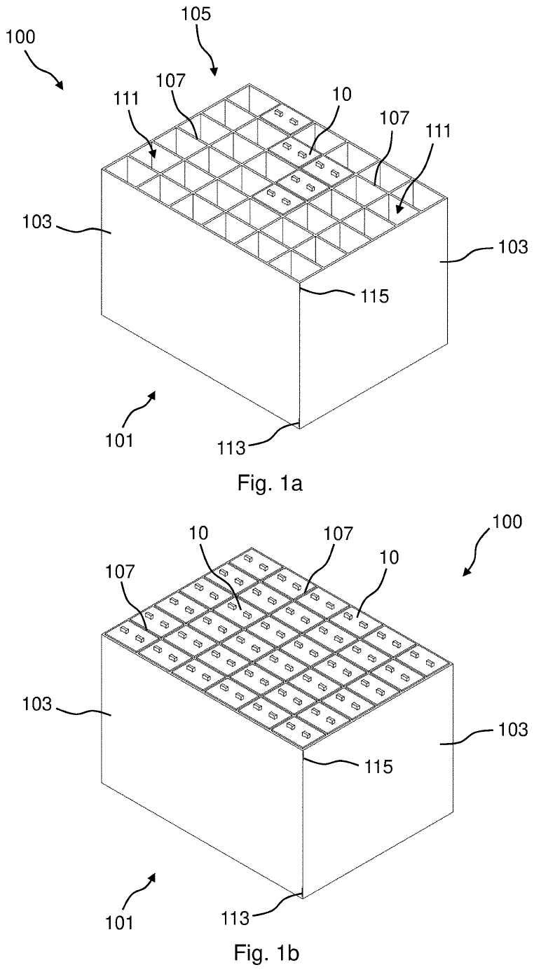

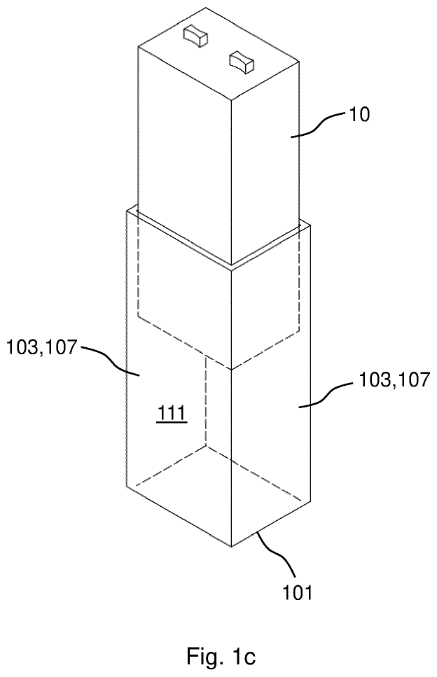

FIGS. 1a and 1b show an isometric view of an example of a tray 100 according to an aspect of the invention. The tray 100 is arranged for housing a plurality of individual battery modules 10 and comprises a bottom wall 101 and side walls 103 defining a receiving space 105 for receiving the plurality of individual battery modules 10. The tray 100 has one or more inner walls 107 extending between opposite side walls 103 and subdividing the receiving space 105 in a plurality of individual battery module receiving chambers 111. Each battery module receiving chambers 111 is bounded by a part of the bottom wall 101 and by one or more side walls 103 and/or inner walls 107. The tray 100 furthermore comprises a coolant inlet 113 and a coolant outlet 115.

FIGS. 1a and 1b show an example of a tray 100 wherein the inner walls 107 of the tray 100 extending perpendicular to each other, thereby subdividing the receiving space 105 in at thirty-six battery module receiving chambers 111 in a matrix-shape of six-by-six battery module receiving chambers 111. In FIG. 1a five battery modules are received in the receiving space 105 of the tray 100, wherein in FIG. 1b all individual battery module receiving chambers 111 of the receiving space 105 of the tray 100 are occupied by an individual battery module 10.

FIG. 1c shows a more detailed isometric view of an individual battery module receiving chamber 111 of the tray 100, bounded by a part of the bottom wall 101 and by one or more side walls 103 and/or inner wall or walls 107, wherein a battery module 10 is placed from the top of the tray 100 into the battery module receiving chambers 111.

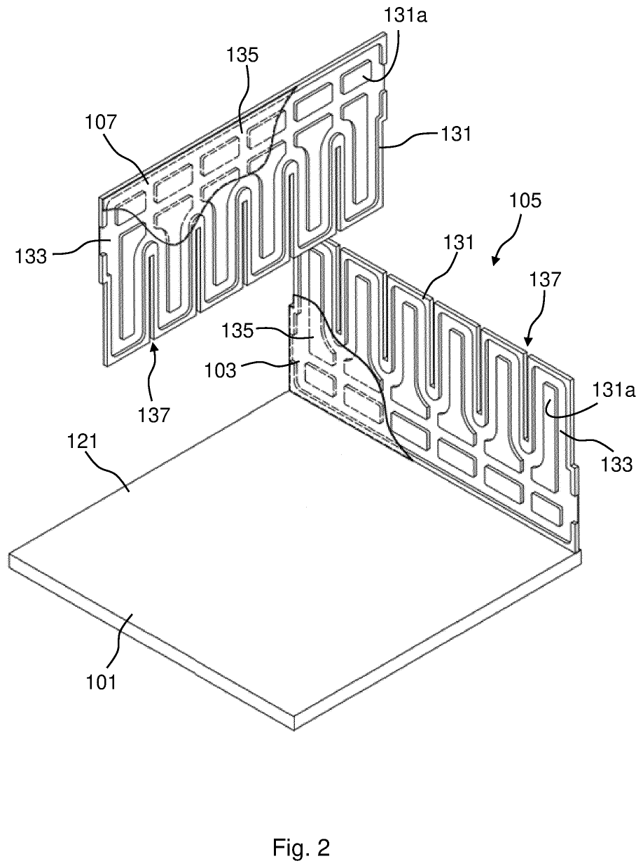

FIG. 2 shows a more detailed isometric view of an example of the bottom wall 101, one of the side walls 103 and one of the inner walls 107 of the tray 100. The bottom wall 101 comprises a plate shaped base part 121 made of a thermoplastic material. At least one of the side walls 103 and/or at least one of the one or more inner walls 107 comprises a plate shaped base part 131 made of a thermoplastic material. The plate shaped base part 131 comprises a wall-channel 133 for a flow of a coolant medium on at least one plate side 131a of the base part 131. The wall-channel 133 is in connection (not shown) with the coolant inlet 113 and with the coolant outlet 115 such that a coolant medium can flow through the wall-channel 133 for cooling of the battery modules 10. The wall-channel 133 can have multiple branches such that the coolant medium flows via the multiple branches in use. Each wall-channel 133 of the side walls 103 and/or at least one of the one or more inner walls 107 can be in direct connection with the coolant inlet 113 and with the coolant outlet 115 or can be in connection with the coolant inlet 113 and with the coolant outlet 115 via one or more of another wall-channel 133. The at least one of the side walls 103 and/or at least one of the one or more inner walls 107 furthermore comprises a thermoplastic-based (preferably polyolefin-based) layer 135, preferably a polyolefin-based film, bonded to the base part 131 such that it covers and thereby closes off the wall-channel 133, wherein the side wall 103 and/or inner wall 107 concerned is oriented in the tray 100 such that it faces one or more of the battery module receiving chambers 111 with a plate side 131a thereof having the layer 135 bonded thereto. The inner walls 107 each comprise one or more slots 137 such that each time two inner walls 107 can be interlocked perpendicular to each other with a first of the two inner walls 107 extending through the slot 137 in the second of the two inner walls 107 and with the second of the two inner walls 107 extending through the slot 137 in the first of the inner walls 107. In each inner wall 107, the at least one wall-channel 133 extends in the inner wall 107 remaining free from the slot 137.

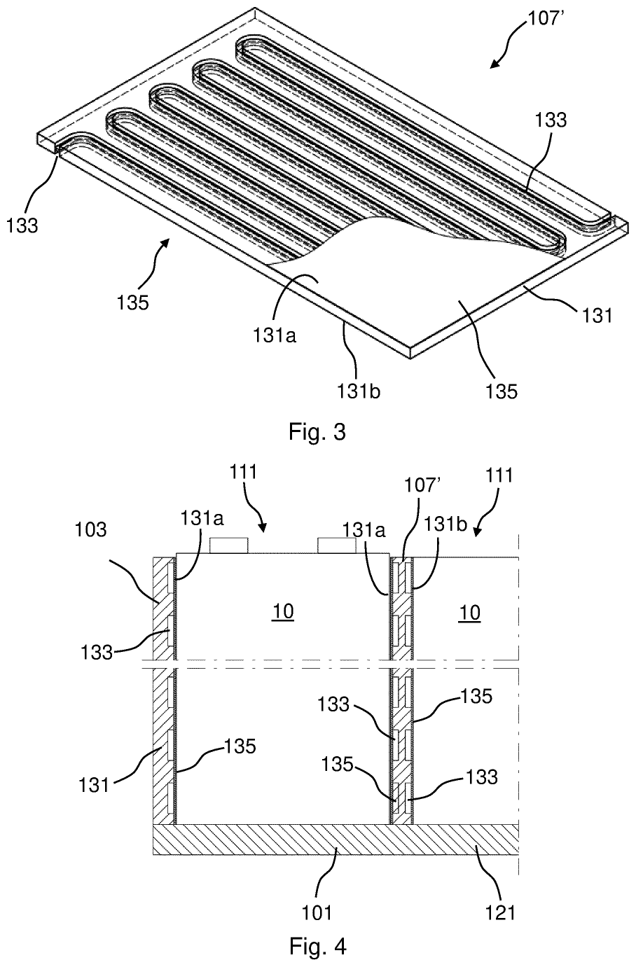

FIG. 3 shows an isometric view of another example of one of the one or more inner walls 107′ of the tray 100, wherein the inner wall 107′ comprises a plate shaped base part 131 comprising a wall-channel 133 on both plate sides 131a, 131b of the base part 131, and a respective thermoplastic-based layer 135 bonded to either plate side 131a, 131b of the base part 131 to cover and thereby close off the respective wall-channel 133.

FIG. 4 shows a cross-sectional view of a part of another embodiment of the tray 100 wherein two battery modules 10 are received in the respective battery module receiving chambers 111, including a bottom wall 101 of the base part 121, a side wall 103 comprising a wall-channel 133 on a plate side 131a of the base part 131 covered by a thermoplastic-based layer 135, and an inner wall 107′ comprising a wall-channel 133 on a plate side 131a of the base part 131 covered by a thermoplastic-based layer 135 and a wall-channel 133 on a plate side 131b of the base part 131 covered by a thermoplastic-based layer 135.

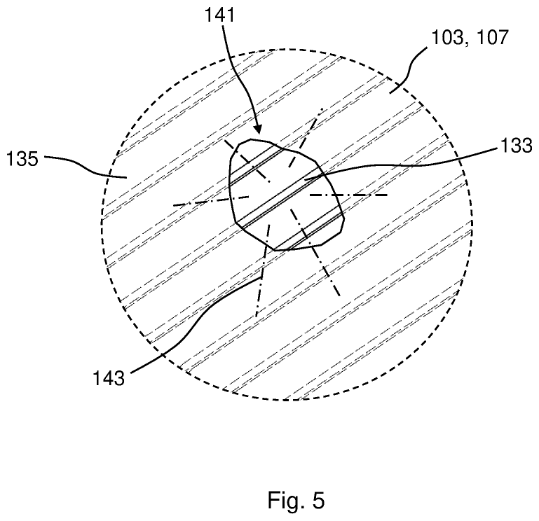

FIG. 5 shows a close-up of a part of one of the side walls 103 and/or one of the one or more inner walls 107, 107′ of the tray 100, in case of overheating of a cell of a battery module 10. Besides being arranged for cooling of the battery modules 10 via one of the side walls 103 and/or one of the one or more inner walls 107, 107′, the side walls 103 and/or one of the one or more inner walls 107, 107′ are arranged as an internal sprinkler system in case of overheating of a cell of a battery module 10, by emerging a spray of coolant medium 143, flowing through the wall-channel 133. For example, the coolant medium 143 comprises water and ethylene glycol and optionally a fire suppressant. A local battery cell failure which leads to the overheating of the cell concerned, results in a local melting of the layer 135 thereby creating a local perforation 141 in the thermoplastic-based layer 135. As a result, the coolant spray 143 immediately emerges from the wall-channel 133, through the perforation 141 and against the battery cell, thereby reducing the temperature locally and contributing to avoiding thermal runaway.

The width and/or depth of the channels (123,133) may be selected depending on several factors, such as the size of the tray 100, the thickness of the walls (101, 103, 107/107′), the thickness of the thermal conductive layer 125 covering the bottom-channels 123 and/or the thickness of the thermoplastic layer 135 covering the wall-channels 133, the types of materials used for the walls as well as the layers covering the walls and the melt, solidification, and/or crystallization characteristics thereof.

In an embodiment, the width of the channels (123,133) is between 0.1 and 5.0 cm, such as between 0.5 and 1.0 cm. In an embodiment, the depth of the channels (123,133) is between 0.5 and 1.0 cm.

The thermoplastic layer 135 may be adhered/bonded to the side walls 103 and/or inner walls 107/107′ by any means known to a person skilled in the art, such as heat stake, or laser or even ultrasound. When present, the thermal conductive layer 125 may be adhered/bonded to the bottom wall 101 in a similar manner.

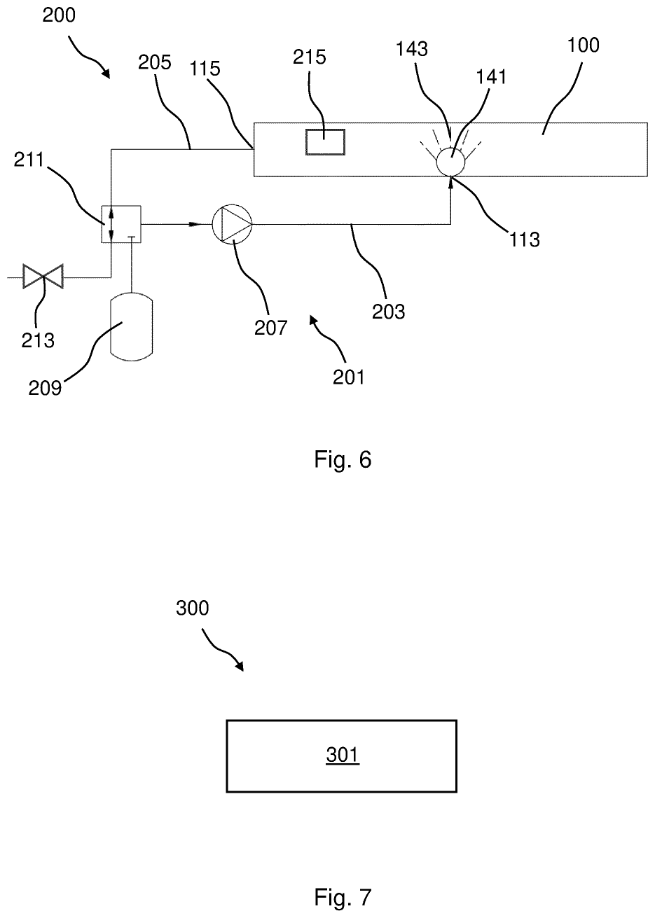

FIG. 6 shows schematically an example of a system 200 according to another aspect of the invention. The system 200 is arranged for housing a plurality of individual battery modules 10 (not shown) and comprises one or more trays 100 according to the aspect of the invention and a cooling system 201. The cooling system 201 comprises a supply line 203 connected to a coolant inlet 113 of each of the one or more trays 100, a discharge line 205 connected to the coolant outlet 115 of each of the one or more trays 100, and a flow generating device 207, such as a pump, for generating a circulating flow of the coolant medium through the supply line 203, via the wall-channel 133 (and optionally the bottom-channel 123) and the discharge line 205. The system 200 furthermore comprises a coolant medium reservoir 209 and/or an external connection for fire responders 213 connected to the supply line 203 or to the discharge line 205 via a valve 211 in such a manner that a coolant medium 143 flows through the wall-channel 133 (and optionally the bottom-channel 123) upon opening the valve 211. In case of a local battery cell failure leads to the overheating of the cell concerned, resulting in a local melting of the layer 135 thereby creating a local perforation 141 in the thermoplastic-based layer 135, the coolant spray 143 and optionally a fire suppressant 143 immediately emerges from the wall-channel 133, through the perforation 141 and against the battery cell, thereby reducing the temperature locally and contributing to avoiding thermal runaway. The system 200 furthermore comprises a pressure sensor 215 for detecting a pressure drop in the wall-channel 133 (and optionally the bottom-channel 123) as a result of a local melting of the thermoplastic-based layer 135 as a result of heat generated by a battery module 10 in the tray 100, wherein the pressure sensor 215 is communicatively connected to the valve 211 such that the valve 211 opens upon detection of the pressure drop by the pressure sensor. The cooling system 201 is configured for pressurizing the coolant medium such that the thermoplastic-based layer 135 (and optionally the thermal conductive layer 125) are elastically stretched as a result of the pressurized coolant medium.

FIG. 7 shows schematically an example of a method 300 according to another aspect of the invention. The method 300 is arranged for cooling a plurality of battery modules 10 housed in a tray 100 of a system 200 according to the invention. The method 300 comprising the step of forcing 301, using the flow generating device 207, a flow of coolant medium and optionally a fire suppressant through the wall-channel 133 (and optionally the bottom-channel 123) in the one or more trays 100. The coolant medium comprises a pressurized coolant fluid, preferably a coolant liquid or a pressurized mixture of a coolant liquid and a gas. For example, the coolant medium comprises water and ethylene glycol and optionally a fire suppressant. Using the cooling system 201, the coolant medium is pressurized such that the thermoplastic-based layer 135 is elastically stretched as a result of the pressurized coolant medium, increasing a heat transfer from the battery modules 10 to the coolant medium as a result of an increased contact between the layer 135 and the battery modules 10.

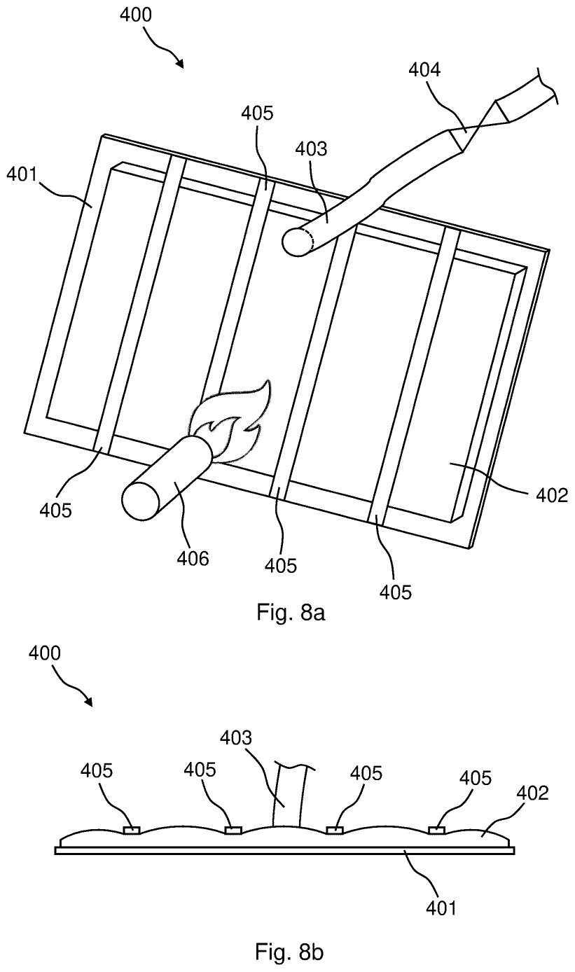

In order to test the working of the wall-channels 133 of this inventive system and method, the following proof-of-concept-test was carried out. In the proof-of-concept-test instead of a tray 100 according to the invention a specialized test set-up was used. This test set-up is shown in FIGS. 8a,b. The specialized set-up 400 consists of a supporting plate 401 in a thermoplastic material having the following dimensions 305 mm×305 mm. This supporting plate 401 mimics a wall (either a side wall 103 or an inner wall 107/107′) of the tray 100 according to the invention. The thermoplastic supporting plate 401 has a thickness of 4 mm and is made of a long glass fiber-filled polypropylene (STAMAX™ available from SABIC). In order to mimic the wall-channels 133 covered with thermoplastic-based layer 135 an off-the-shelf thermoplastic bag 402 was used. This thermoplastic bag 402 is made of a 51-micrometer thick layer of thermoplastic-based material and has the following dimensions 305 mm×229 mm. The thermoplastic bag 402 is obtained from Cole-Palmer® (ESS GD0912-7000 Sampling Bag with Combination Valve, 3 L) and is a gas sampling bags constructed of 2 micrometer thick Tedlar® material with solid seam. The thermoplastic bag 402 includes polypropylene combination valve ( 3/16″ OD on/off stem) and an integral PTFE silicone septum. The thermoplastic bag 402 has a volume of 3 L and has valves for attachment of the coolant inlet 113 and coolant outlet 115. Tedlar® material of DuPont™ is a polyvinyl fluoride (PVF) material (which is a thermoplastic material) having a melting point near 190° C. The coolant inlet 113 of the thermoplastic bag 402 was attached via a pressure regulator 404 to a supply line 203 (garden hose) to supply regular water as coolant medium 143. The thermoplastic bag 402 was connected to a water hose via a regulator with pressure control between 35-70 kPa. The thermoplastic bag 402 was then placed on top of the supporting plate 401 and clamped into position using four aluminum metal bars 405 that allow the formation of five expanded sections comprising pressurized coolant medium 143. These five expanded section mimic the wall-channels 133. The metal bars 405 have a thickness of 6.35 mm, a width of 6.35 mm, and a length of 305 mm and are placed with a spacing of approximately 70 mm. These bars 405 are clamped using eight 2-inch QUICK-GRIP Resin Spring Clamps (not shown), one for each end of each bar. After the thermoplastic bag 402 was secured to the supporting plate 401, a flame torch 406 was used to mimic thermal runaway of a battery module 10. The flame torch 406 was an air-fed methane flame torch the flame of which was adjusted along with the distance to get a surface temperature around 800° C. the flame torch 406 was held at a distance of approximately 12 cm from the thermoplastic bag 402 and within seconds after heating of the thermoplastic bag 402, a local perforation 141 was obtained by the local melting of the thermoplastic bag resulting in a clear spray of the coolant medium 143. This proof-of-concept test clearly shows that the system and method according to the present invention works.

Other variations to the disclosed embodiments can be understood and effected by those skilled in the art in practicing the claimed invention, from a study of the drawings, the disclosure, and the appended claims. The scope of the present invention is defined by the appended claims. One or more of the objects of the invention are achieved by the appended claims.

### LIST OF REFERENCE NUMERALS

10: individual battery modules
100: tray
101: bottom wall
103: side wall
105: receiving space
107/107′: inner wall
111: battery module receiving chamber
113: coolant inlet
115: coolant outlet
121: plate shaped base part
123: bottom-channel
125: thermal conductive layer
131: plate shaped base part
131a/131b: plate side
133: wall-channel
135: thermoplastic-based layer
137: slot
141: perforation
143: coolant medium
200: system
201: cooling system
203: supply line
205: discharge line
207: flow generating device
209: coolant medium reservoir
211: valve
213: external connection for fire responders
215: pressure sensor
300: method
301: step of forcing
400: test set-up
401: supporting plate
402: thermoplastic bag
403: water connector
404: pressure regulator
405: metal bar
406: flame torch

1. A tray for housing a plurality of individual battery modules, the tray comprising a bottom wall and side walls defining a receiving space for the plurality of individual battery modules, wherein the tray has one or more inner walls extending between opposite side walls and subdividing the receiving space in a plurality of individual battery module receiving chambers each bounded by a part of the bottom wall and by one or more side walls and/or inner wall or walls, and a coolant inlet and a coolant outlet,
wherein at least one of the side walls and/or at least one of the one or more inner walls comprises:
a plate shaped base part made of a thermoplastic material and comprising a wall-channel for a flow of a coolant medium on at least one plate side of the base part, wherein the wall-channel is in connection with the coolant inlet and with the coolant outlet such that a coolant medium can flow through the wall-channel, and
a thermoplastic-based layer, bonded to the base part such that it covers and thereby closes off the wall-channel,
wherein the wall concerned is oriented in the tray such that it faces one or more of the battery module receiving chambers with a plate side thereof having the layer bonded thereto.

2. The tray according to claim 1, wherein at least one of the one or more inner walls comprises a plate shaped base part comprising a said wall-channel on both plate sides of the base part, and a respective said thermoplastic-based layer bonded to either plate side of the base part to cover and thereby close off the respective wall-channel.

3. The tray according to claim 2, wherein the wall-channel has multiple branches such that the coolant medium flows via the multiple branches in use.

4. The tray according to claim 3, wherein the bottom wall as well comprises a said plate shaped base part made of a thermoplastic material and comprising a bottom-channel for a flow of a coolant medium on at least one plate side of the base part, wherein the bottom-channel is in connection with the coolant inlet and with the coolant outlet such that a coolant medium can flow through the bottom-channel, the bottom wall further comprising a thermal conductive layer, bonded to the base part such that it covers and thereby closes off the bottom-channel, wherein the bottom wall is oriented such that it faces the receiving space with an inner plate side thereof having the layer bonded thereto.

5. The tray according to claim 4, wherein at least 20 percent of a plate surface of each wall part enclosing each of the battery module chambers is free from the wall-channel so as to serve as an abutment for positioning the battery module in the chamber concerned.

6. The tray according to claim 5, wherein inner walls of the tray extending perpendicular to each other subdivide the receiving space in at least four said battery module receiving chambers in a matrix-shape of at least two by at least two battery module receiving chambers,
wherein the inner walls each comprise a slot such that each time two inner walls can be interlocked perpendicular to each other with a first of the two inner walls extending through the slot in the second of the two inner walls and with the second of the two inner walls extending through the slot in the first of the inner walls,
wherein, in each inner wall, the at least one wall-channel extends in the inner wall remaining free from the slot.

7. A system for housing a plurality of individual battery modules, comprising:
one or more trays according to any one of the preceding claims; and
a cooling system comprising:
a supply line connected to a coolant inlet of each of the one or more trays;
a discharge line connected to the coolant outlet of each of the one or more trays; and
a flow generating device, such as a pump, for generating a circulating flow of the coolant medium through the supply line, via the wall-channel and the discharge line.

8. The system according to claim 7, further comprising a coolant medium reservoir connected to the supply line or to the discharge line via a valve in such a manner that said coolant medium flows through the wall-channel upon opening the valve.

9. The system according to claim 8, comprising a pressure sensor for detecting a pressure drop in the wall-channel as a result of a local melting of the thermoplastic-based layer as a result of heat generated by a battery module in the tray, wherein the pressure sensor is connected to the valve such that the valve opens upon detection of said pressure drop by the pressure sensor.

10. The system according to claim 9, wherein the cooling system is configured for pressurizing the coolant medium such that the thermoplastic-based layer is elastically stretched as a result of the pressurized coolant medium.

11. A method for cooling a plurality of battery modules housed in a tray of a system according to claim 10, comprising:
forcing, using the flow generating device, a flow of coolant medium through the wall-channel in the one or more trays.

12. The method according to claim 11, wherein the coolant medium comprises a pressurized coolant fluid.

13. The method according to claim 11, wherein, using the cooling system, the coolant medium is pressurized such that the thermoplastic-based layer is elastically stretched as a result of the pressurized coolant medium, increasing a heat transfer from the battery modules to the coolant medium as a result of an increased contact between the layer and the battery modules.

14. The tray according to claim 1, wherein the thermoplastic-based layer is a polyolefin-based layer.

15. The tray according to claim 1, wherein the thermoplastic-based layer is a polyolefin-based film.

16. The tray according to claim 4, wherein the thermal conductive layer is a thermal conductive film.

17. The method according to claim 11, wherein the coolant medium comprises a coolant liquid.

18. The method according to claim 11, wherein the coolant medium comprises a pressurized mixture of a coolant liquid and a gas.

19. The method according to claim 11, wherein the coolant medium comprises water and ethylene glycol.

20. The method according to claim 19, wherein the coolant medium further comprises a fire suppressant.
